(19) United States
(12) Patent Application Publication
(10) Pub. No.: US 2020/0200033 A1
(43) Pub. Date: Jun. 25, 2020

(54) TURBO MACHINE

(71) Applicant: MITSUBISHI HEAVY INDUSTRIES, LTD., Tokyo (JP)

(72) Inventors: Hitoshi KITAGAWA, Tokyo (JP); Daigo FUJIMURA, Tokyo (JP)

(21) Appl. No.: 16/620,096

(22) PCT Filed: Jul. 9, 2018
(86) PCT No.: PCT/JP2018/025932

§ 371 Date: Dec. 6, 2019

(30) Foreign Application Priority Data
Jul. 10, 2017 (JP) 2017-134787

(51) Int. Cl. F01D 11/08; F01D 11/14

(52) U.S. Cl. CPC F01D 11/08; F05D 2240/55; F01D 11/14

(57) ABSTRACT

A turbo machine includes a casing in which fluid flows; turbine blades arranged side by side in a circumferential direction with respect to a rotational shaft rotatably provided in the casing; a ring segment forming an inner surface of the casing; a seal fin provided as an extension at a tip end part of each turbine blade and facing the ring segment; and a seal member through which the turbo machine faces the seal fin, the seal member having a first inner surface that accepts contact of the seal fin. The ring segment has a second inner surface incrementally enlarging toward a downstream side in an axial direction of the rotational shaft. The first and second inner surfaces are connected with each other without a step between the inner surfaces on the downstream side of the first inner surface in the axial direction.

### FIELD

The present invention relates to a turbo machine.

### BACKGROUND

In a turbo machine, a loss in kinetic energy for rotating a turbine blade is sometimes caused by interference of leakage flow of fluid at a tip end part of the turbine blade with the main stream rotating the turbine blade, and it has been desired to reduce the loss.

For example, Patent Literature 1 discloses a turbo machine including a housing having an inner surface, a compressor disposed in the housing, a turbine disposed in the housing and operatively connected with the compressor, a rotation member including a plurality of turbine blades (blade members) formed as part of the compressor and the turbine and each including a base end portion and a tip end part, and a honeycomb seal member disposed adjacent to the rotation member and attached to the inner surface of the housing.

### CITATION LIST

### Patent Literature

Patent Literature 1: Japanese Patent Laid-open No. 2011-080469

### SUMMARY

### Technical Problem

In Patent Literature 1 described above, the honeycomb seal member includes a shaped surface having a deformation zone formed by the tip end part of each turbine blade. The deformation zone includes an entrance zone and an exit zone. The entrance zone is configured and disposed to receive air flow from one upstream end portion of the compressor and the turbine, and the exit zone is configured and disposed to cause the air flow to flow toward one downstream end portion of the compressor and the turbine. The entrance zone is disposed at an interval of a first distance from the tip end part of each turbine blade, and the exit zone is disposed at an interval of a second distance from the tip end part of each turbine blade. The second distance is substantially equal to or smaller than the first distance so that front-end leakage air flow flowing from the deformation zone has a substantially streamline shape. In this manner, in Patent Literature 1, since the front-end leakage air flow flowing from the deformation zone has a substantially streamline shape, interaction between the main stream rotating each turbine blade and the front-end leakage air flow decreases and operation of the turbo machine is reinforced.

However, in Patent Literature 1, the honeycomb seal member is provided with the shaped surface including the deformation zone, but the shape of the shaped surface is formed through shaving by the tip end part of any turbine blade, and thus the shape of the shaped surface of the honeycomb seal member for causing the front-end leakage air flow to have a streamline shape depends on operating conditions and the like. Furthermore, the tip end part of each turbine blade relatively moves in the axial direction due to thermal deformation of a rotor shaft in turbine operation and relatively moves in the radial direction due to thermal expansion of the turbine blade, and thus it is not always possible to reliably achieve an expected effect with the actual machine.

The present invention is intended to solve the above-described problem, and an object thereof is to provide a turbo machine capable of reducing a loss in kinetic energy for rotating a turbine blade caused by interference of leakage flow at a tip end part of the turbine blade with a main stream rotating the turbine blade.

### Solution to Problem

To achieve the object described above, a turbo machine according to one aspect of the present invention includes a casing in which fluid flows; a plurality of turbine blades arranged side by side in a circumferential direction with respect to a rotational shaft rotatably provided in the casing; a ring segment forming an inner surface of the casing; and a seal fin provided as an extension at a tip end part of each turbine blade and facing the ring segment. The ring segment includes a seal member through which the turbo machine faces the seal fin, the seal member having a first inner surface that accepts contact of the seal fin. The ring segment has a second inner surface incrementally enlarging toward a downstream side in an axial direction of the rotational shaft. The first inner surface and the second inner surface are connected with each other without a step between the inner surfaces on the downstream side of the first inner surface in the axial direction. In other words, the ring segment is composed of a ring segment body that is a rigid body, and a seal member that is excellent in shaving easiness.

According to the turbo machine, since the seal fin closely faces the first inner surface of the ring segment, it is possible to reduce the amount of fluid (leakage flow) passing toward the downstream side in the axial direction along the first inner surface between each turbine blade and the first inner surface facing thereto.

In addition, according to the turbo machine, since the first inner surface includes the seal member, the seal member is shaved when the seal fin contacts the first inner surface facing thereto due to change in operating conditions, thereby preventing damage on the seal fin and the ring segment.

Moreover, according to the turbo machine, since leakage flow between the seal fin and the first inner surface facing thereto is guided along the second inner surface toward the outer side in the radial direction in which the second inner surface expands and the downstream side in the axial direction, it is possible to reduce generation of vortex flow that would interfere with the main stream on the downstream side of the first inner surface in the axial direction.

According to the turbo machine, a downstream surface of the seal member included in the first inner surface on the downstream side in the axial direction is covered by the ring segment on the downstream side of the first inner surface in the axial direction, thereby avoiding exposure of the downstream surface. Since the first inner surface and the second inner surface are connected with each other without a step, no stepped part that would generate vortex flow is formed at the connection part.

Accordingly, even when operation is performed while the seal fin does not contact the seal member and a gap is maintained or when the seal member is shaved by the seal fin due to change in the operation state and the surface shape of the seal member is changed, it is possible to reduce interference of leakage flow having passed between the first inner surface and the seal fin with the main stream rotating the turbine blade, and thus it is possible to reliably obtain an expected effect with the actual machine.

To achieve the object described above, a turbo machine according to one aspect of the present invention includes a casing in which fluid flows; a plurality of turbine blades arranged side by side in a circumferential direction with respect to a rotational shaft rotatably provided in the casing; a ring segment forming an inner surface of the casing; and a seal fin provided as an extension at a tip end part of each turbine blade and facing the ring segment. The turbo machine includes a seal member through which the turbo machine faces the seal fin, the seal member having a first inner surface that accepts contact of the seal fin. The ring segment has a second inner surface incrementally enlarging toward a downstream side in an axial direction of the rotational shaft. The first inner surface and the second inner surface are connected with each other on the downstream side in the axial direction of the first inner surface with a step such that the first inner surface protrudes on an inner side with respect to the second inner surface in a radial direction, the step being smaller than a thickness of the seal member.

According to the turbo machine, since the seal fin closely faces the first inner surface of the ring segment, it is possible to reduce the amount of fluid (leakage flow) passing toward the downstream side in the axial direction along the first inner surface between each turbine blade and the first inner surface facing thereto.

In addition, according to the turbo machine, since the first inner surface includes the seal member, the seal member is shaved when the seal fin contacts the first inner surface facing thereto due to change in operating conditions, thereby preventing damage on the seal fin and the ring segment.

Moreover, according to the turbo machine, since leakage flow between the seal fin and the first inner surface facing thereto is guided along the second inner surface toward the outer side in the radial direction in which the second inner surface expands and the downstream side in the axial direction, it is possible to reduce generation of vortex flow that would interfere with the main stream on the downstream side of the first inner surface in the axial direction.

Accordingly, even when operation is performed while the seal fin does not contact the seal member and a gap is maintained or when the seal member is shaved by the seal fin due to change in the operation state and the surface shape of the seal member is changed, it is possible to reduce interference of leakage flow having passed between the first inner surface and the seal fin with the main stream rotating the turbine blade, and thus it is possible to reliably obtain an expected effect with the actual machine.

Moreover, according to the turbo machine, since connection is made with a step with which the first inner surface protrudes on the inner side of the second inner surface in the radial direction on the downstream side of the first inner surface in the axial direction, and the step is smaller than the thickness of the seal member, the seal fin can be prevented from contacting the second inner surface when the position of any turbine blade in the axial direction is moved relative to the ring segment due to thermal deformation or the like and the seal fin of the turbine blade contacts the seal member, thereby preventing damage on the seal fin and the second inner surface.

To achieve the object described above, a turbo machine according to one aspect of the present invention includes a casing in which fluid flows; a plurality of turbine blades arranged side by side in a circumferential direction to a rotational shaft rotatably provided in the casing; a ring segment forming an inner surface of the casing; and a seal fin provided as an extension at a tip end part of each turbine blade and facing the ring segment. The turbo machine includes a seal member facing the seal fin as an extension at the tip end part of each turbine blade at a last stage and having a first inner surface that accepts contact of the seal fin is provided. The ring segment has a second inner surface having an inner diameter incrementally increasing toward a downstream side in an axial direction of the rotational shaft. The first inner surface and the second inner surface are connected with each other on the downstream side in the axial direction of the first inner surface with a step such that the first inner surface protrudes on an inner side with respect to the second inner surface in a radial direction.

According to the turbo machine, since the seal fin closely faces the first inner surface of the ring segment, it is possible to reduce the amount of fluid (leakage flow) passing toward the downstream side in the axial direction along the first inner surface between each turbine blade and the first inner surface facing thereto.

In addition, according to the turbo machine, since the first inner surface includes the seal member, the seal member is shaved when the seal fin contacts the first inner surface facing thereto due to change in operating conditions, thereby preventing damage on the seal fin and the ring segment.

Moreover, according to the turbo machine, since leakage flow between the seal fin and the first inner surface facing thereto is guided along the second inner surface toward the outer side in the radial direction in which the second inner surface expands and the downstream side in the axial direction, it is possible to reduce generation of vortex flow that would interfere with the main stream on the downstream side of the first inner surface in the axial direction.

Accordingly, even when operation is performed while the seal fin does not contact the seal member and a gap is maintained or when the seal member is shaved by the seal fin due to change in the operation state and the surface shape of the seal member is changed, it is possible to reduce interference of leakage flow having passed between the first inner surface and the seal fin with the main stream rotating the turbine blade, and thus it is possible to reliably obtain an expected effect with the actual machine.

Moreover, according to the turbo machine, since the first and the second inner surfaces are connected with each other with a step between the inner surfaces on the downstream side of the first inner surface in the axial direction so that the first inner surface protrudes on an inner side of the second inner surface in a radial direction, the seal fin can be prevented from contacting the second inner surface when the position of any turbine blade in the axial direction is moved relative to the ring segment due to thermal deformation or the like and the seal fin of the turbine blade contacts the seal member, thereby preventing damage on the seal fin and the second inner surface.

Further, in the turbo machine according to one aspect of the present invention, it is preferable that the seal member has a tilted inner surface as part of a radial-direction inner surface tilted outward in the radial direction, and the second inner surface is provided continuously with the tilted inner surface.

According to the turbo machine, the second inner surface can be disposed on the outer side of the radial-direction inner surface of the seal member included in the first inner surface in the radial direction through the tilted inner surface. Accordingly, the seal fin can be prevented from contacting the second inner surface when the position of any turbine blade in the axial direction is moved relative to the ring segment due to thermal deformation or the like and the seal fin of the turbine blade contacts the seal member, thereby preventing damage on the seal fin and the second inner surface.

Further, in the turbo machine according to one aspect of the present invention, it is preferable that the first inner surface and the second inner surface connected with the first inner surface on the downstream side in the axial direction have no step discontinuous in the axial direction except for the protrusion of the seal member.

According to the turbo machine, since there is no step discontinuous in the axial direction except for the protrusion of the seal member, vortex generation due to a step can be prevented.

Further, in the turbo machine according to one aspect of the present invention, it is preferable that the amount of the protrusion of the seal member is larger than a depth to which shaving by the seal fin is expected and smaller than twice of the depth.

According to the turbo machine, since the amount of the protrusion of the seal member is larger than the depth to which shaving of the seal member when the seal fin of any turbine blade contacts the seal member is expected, the seal fin can be prevented from contacting the ring segment when the seal fin of any turbine blade contacts the seal member. In addition, since the amount of the protrusion of the seal member is smaller than twice of the depth, vortex generation due to a step can be reduced as much as possible.

Further, in the turbo machine according to one aspect of the present invention, it is preferable that the second inner surface is integrated with the ring segment.

According to the turbo machine, since the second inner surface is formed integrally with the ring segment, the number of components is reduced.

Further, in the turbo machine according to one aspect of the present invention, it is preferable that the second inner surface is provided separately from the ring segment.

According to the turbo machine, since the second inner surface is provided separately from the ring segment, the seal member can be easily replaced, which leads to improved maintainability.

Further, in the turbo machine according to one aspect of the present invention, it is preferable that an upstream surface of the seal member that faces toward an upstream side in the axial direction of the rotational shaft protrudes from the inner surface of the ring segment.

According to the turbo machine, a vertex is generated on the inner side of the radial-direction inner surface of the seal member included in the first inner surface in the radial direction and the upstream side of the seal fin in the axial direction and encumbers flow toward the gap between the radial-direction inner surface as the first inner surface and the front end of the seal fin. Accordingly, it is possible to reduce fluid leakage from the gap and interference of this leakage flow with the main stream, thereby significantly achieving the effect of reducing a loss in the kinetic energy of fluid rotating the turbine blade.

### Advantageous Effects of Invention

According to the present invention, it is possible to reduce interference of leakage flow at a tip end part of a turbine blade with a main stream rotating the turbine blade, and thus it is possible to reduce a loss in kinetic energy for rotating the turbine blade.

### BRIEF DESCRIPTION OF DRAWINGS

FIG. 1 is a schematic configuration diagram of a gas turbine according to an embodiment of the present invention.

FIG. 2 is a perspective view of turbine blades of the gas turbine according to the embodiment of the present invention.

FIG. 3 is an enlarged view of the vicinity of a turbine blade tip end part of the gas turbine according to the embodiment of the present invention.

FIG. 4 is an enlarged view of the vicinity of another exemplary turbine blade tip end part of the gas turbine according to the embodiment of the present invention.

FIG. 5 is an enlarged view of the vicinity of another exemplary turbine blade tip end part of the gas turbine according to the embodiment of the present invention.

FIG. 6 is an enlarged view of the vicinity of another exemplary turbine blade tip end part of the gas turbine according to the embodiment of the present invention.

FIG. 7 is an enlarged view of the vicinity of another exemplary turbine blade tip end part of the gas turbine according to the embodiment of the present invention.

FIG. 8 is an enlarged view of the vicinity of another exemplary turbine blade tip end part of the gas turbine according to the embodiment of the present invention.

### DESCRIPTION OF EMBODIMENTS

The following describes an embodiment according to the present invention in detail with reference to the accompanying drawings. The present invention is not limited to the present embodiment. Components in the embodiment described below include those easily replaceable by the skilled person in the art or those identical in effect.

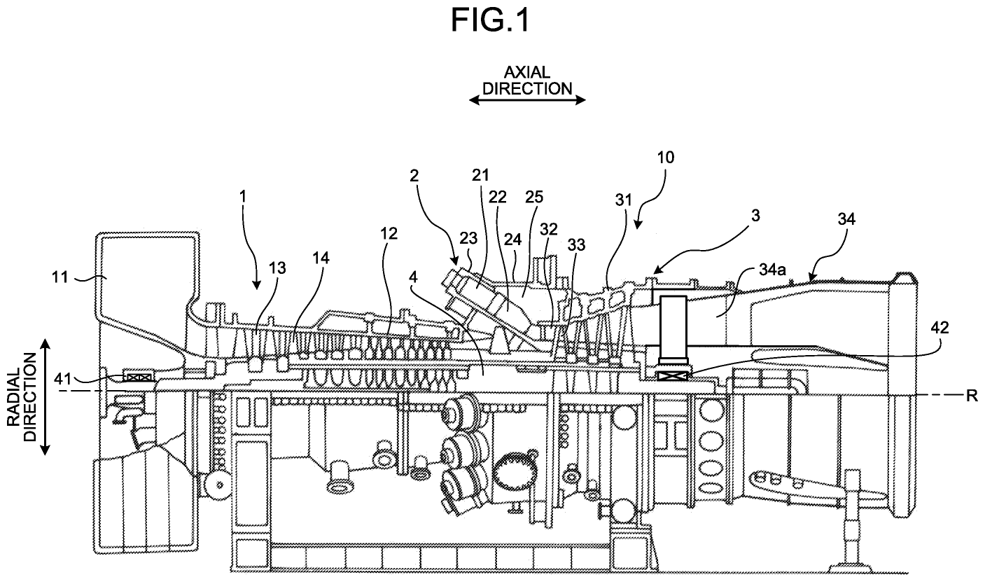

FIG. 1 is a schematic configuration diagram of a gas turbine according to the present embodiment.

In the present embodiment, an industrial gas turbine 10 illustrated in FIG. 1 is an exemplary turbo machine. Other examples of such a turbo machine include a steam turbine and an aviation turbine.

As illustrated in FIG. 1, the gas turbine 10 includes a compressor 1, a combustor 2, and a turbine 3. In the gas turbine 10, a rotor shaft 4 as a rotational shaft is disposed to penetrate through central parts of the compressor 1, the combustor 2, and the turbine 3. The compressor 1, the combustor 2, and the turbine 3 are sequentially arranged side by side from the upstream side toward the downstream side in gas flow along a center axis R of the rotor shaft 4. In the following description, an axial direction is a direction parallel to the center axis R, a circumferential direction is a direction about the center axis R at the center, and a radial direction is a direction orthogonal to the center axis R. The inner side in the radial direction is a side closer to the center axis R in the radial direction, and the outer side in the radial direction is a side away from the center axis R in the radial direction.

The compressor 1 generates compressed air by compressing air. The compressor 1 includes a compressor vane 13 and a compressor rotor blade 14 in a compressor casing 12 including an air intake 11 through which air is taken in. A plurality of compressor vanes 13 are arranged side by side in the circumferential direction and attached on the compressor casing 12 side. A plurality of compressor rotor blades 14 arranged side by side in the circumferential direction and attached on the rotor shaft 4 side. The compressor vanes 13 and the compressor rotor blades 14 are alternately provided in the axial direction.

The combustor 2 generates high-temperature and high-pressure combusted gas by supplying fuel to the compressed air obtained through compression at the compressor 1. The combustor 2 includes, as a combustion chamber, a combustor basket 21 in which the compressed air and the fuel are mixed and combusted, a transition piece 22 through which the combusted gas is guided from the combustor basket 21 to the turbine 3, and a combustor outer shell 23 serving as a flow path 25 that covers the outer periphery of the combustor basket 21 and through which the compressed air from the compressor 1 is guided to the combustor basket 21. A plurality of such combustors 2 are arranged side by side to a combustor casing 24 in the circumferential direction.

The turbine 3 generates rotational power from the combusted gas obtained through combustion at the combustor 2. The turbine 3 includes a turbine stator vane 32 and a turbine blade 33 in a turbine casing 31. A plurality of turbine stator vanes 32 are arranged side by side in the circumferential direction and attached the turbine casing 31 side. A plurality of turbine blades 33 are arranged side by side in the circumferential direction and attached on the rotor shaft 4 side. The turbine stator vanes 32 and the turbine blades 33 are alternately provided in the axial direction. A exhaust manifold 34 including a exhaust diffuser 34a continuous with the turbine 3 is provided on the downstream side of the turbine casing 31 in the axial direction.

The rotor shaft 4 is provided rotatably about the center axis R with an end part on the compressor 1 side being supported by a bearing 41 and with an end part on the exhaust manifold 34 side being supported by a bearing 42. Although not clearly illustrated, the end part of the rotor shaft 4 on the compressor 1 side is coupled with the drive shaft of an electric generator.

In the gas turbine 10 thus configured, air taken in through the air intake 11 of the compressor 1 is compressed into high-temperature and high-pressure compressed air while passing through the compressor vanes 13 and the compressor rotor blades 14. The compressed air is mixed with the fuel and combusted at the combustor 2, thereby generating high-temperature and high-pressure combusted gas. Then, the rotor shaft 4 is rotated as the combusted gas passes through the turbine stator vanes 32 and the turbine blades 33 of the turbine 3, thereby providing rotational power to the electric generator coupled with the rotor shaft 4 to perform power generation. Then, the combusted gas having rotated the rotor shaft 4 is discharged as exhaust gas into atmosphere through the exhaust diffuser 34a of the exhaust manifold 34.

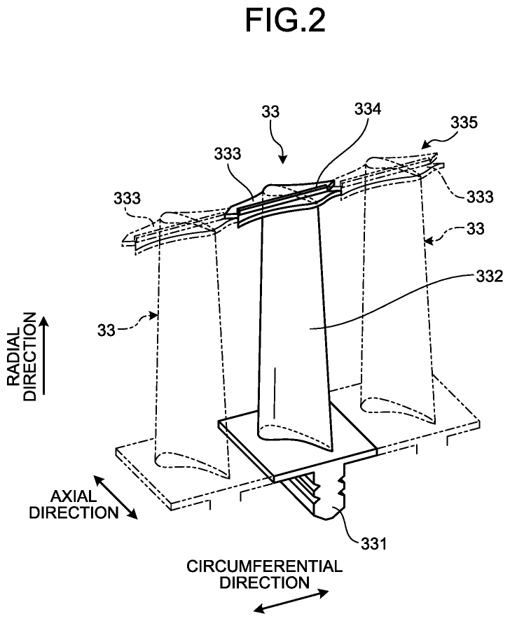

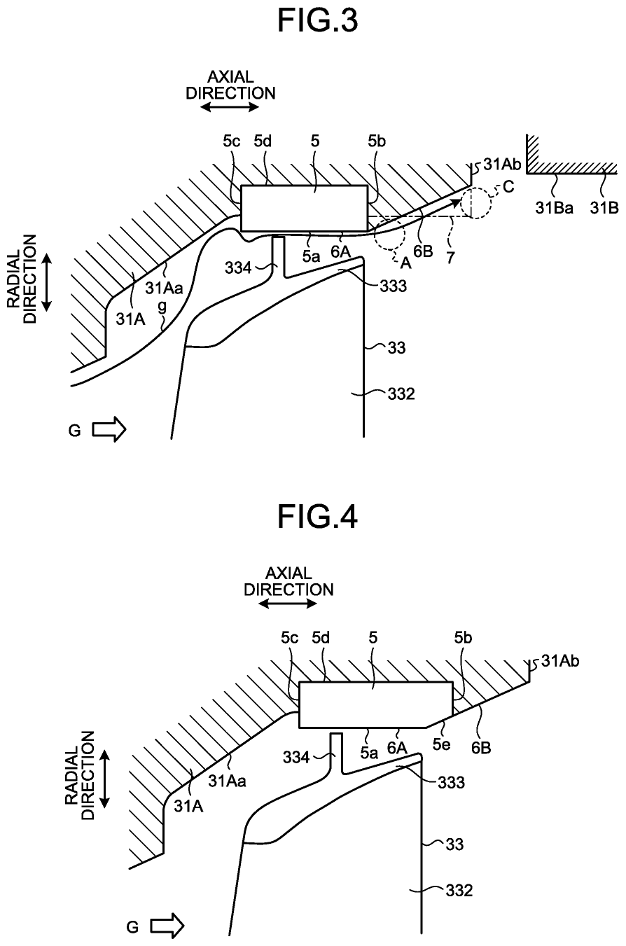

FIG. 2 is a perspective view of turbine blades of the gas turbine according to the present embodiment. FIGS. 3 to 8 are each an enlarged view of the vicinity of a turbine blade tip end part of the gas turbine according to the present embodiment.

As illustrated in FIG. 2, each turbine blade (also simply referred to as blade) 33 is constituted by a blade root 331 fixed to a disk (the rotor shaft 4), a blade airfoil portion 332 having a base end part joined to the blade root 331, a tip shroud 333 coupled with a tip end part of the blade airfoil portion 332, and a seal fin 334 formed as an extension on the outer surface of the tip shroud 333 in the radial direction. The blade airfoil portion 332 extends in the radial direction and is twisted by a predetermined angle. The tip shroud 333 is formed in a plate shape extending in the circumferential direction and the axial direction. The seal fin 334 is formed as a convex rib extending in the circumferential direction. When the blade roots 331 of the turbine blades 33 are disposed in the circumferential direction in engagement with an outer peripheral portion of the disk, the tip shrouds 333 are connected in contact with each other and the seal fins 334 are continuous with each other in the circumferential direction, thereby forming a shroud 335 having an annular shape on the outer periphery sides (tip end parts) of the vane bodies 332.

The turbine casing 31 houses the turbine blades 33 inside. As illustrated in FIG. 3, the combusted gas (fluid) flows inside the turbine casing 31 in the axial direction indicated with Arrow G. The rotor shaft 4 is rotated as the combusted gas passes through the turbine blades 33 and the turbine stator vanes 32. The inner surface of the turbine casing 31 is provided by a ring segment 31A. The ring segment 31A is a rigid body and disposed in an annular shape in the circumferential direction while surrounding from outside the turbine blades 33 in the radial direction. A seal member 5 is fixed to an inner surface 31Aa of the ring segment 31A. For example, the seal member 5 may have a honeycomb structure in which hexagonal tubular bodies opened in the radial direction are arranged side by side in the circumferential direction and the axial direction, or may be aluminum alloy material deposited in a plate shape in the circumferential direction. The seal member 5 is formed in a rectangular sectional shape having a radial-direction inner surface 5a extending in the circumferential direction on the inner side in the radial direction and closely facing the seal fins 334 of the turbine blades 33, a downstream surface 5b extending in the radial direction and facing toward the downstream side in the flow direction (Arrow G) of the combusted gas (downstream side in the axial direction in which the rotor shaft 4 as the rotational shaft extends), an upstream surface 5c extending in the radial direction and facing toward the upstream side in the flow direction (Arrow G) of the combusted gas (upstream side in the axial direction in which the rotor shaft 4 as the rotational shaft extends), and a radial-direction outer surface 5d provided opposite to the radial-direction inner surface 5a and facing outward in the radial direction. The radial-direction inner surface 5a of the seal member 5 and the front end of each seal fin 334 closely face each other, so that the seal member 5 and the seal fin 334 reduce leakage of the combusted gas in Flow direction g at the tip end part of the turbine blade 33. Simultaneously, the seal member 5 allows rotation of the turbine blade 33 by forming a gap between the radial-direction inner surface 5a and the front end of the seal fin 334, and when the turbine blade 33 becomes positioned further on the outer side in the radial direction due to thermal expansion or the like and the seal fin 334 contacts the seal member 5, the seal member 5 is shaved to prevent damage on the seal fin 334. In other words, the seal member 5 accepts contact of the seal fin 334. The surface of the seal member 5 opposite to the seal fin 334 (the radial-direction inner surface 5a) is provided parallel to the rotor shaft 4. With this configuration, clearance between the seal fin 334 and the seal member 5 can be maintained when the rotor shaft 4 expands in the axial direction due to heat.

As illustrated in FIG. 3, the gas turbine 10 according to the present embodiment has a first inner surface 6A and a second inner surface 6B.

The first inner surface 6A includes the radial-direction inner surface 5a of the seal member 5 fixed to the ring segment 31A, and is a surface constantly facing the seal fin 334. “Constantly” means operational and stopped states of the gas turbine 10.

The second inner surface 6B is connected with the first inner surface 6A on the downstream side of the first inner surface 6A in the axial direction. The second inner surface 6B serves as, separately from the seal member 5, an end part of the ring segment 31A on the downstream side in the axial direction. The second inner surface 6B has an inner diameter increasing from a part connected with the first inner surface 6A toward the downstream side in the axial direction. In other words, the second inner surface 6B is connected with the first inner surface 6A including the seal member 5 on the downstream side in the axial direction, and serves as a tilted surface further incrementally expanding at a tilt from this connection part outward in the radial direction toward the downstream side in the axial direction in the ring segment as a rigid body different from the seal member 5.

As illustrated in FIG. 3, a downstream surface 31Ab facing the downstream side in the flow direction (Arrow G) of the combusted gas (downstream side in the axial direction) is provided at the downstream end of the second inner surface 6B in the axial direction and the downstream end of the ring segment 31A in the axial direction. A downstream casing 31B facing the downstream surface 31Ab in the axial direction with a gap interposed therebetween is provided on the downstream side of the downstream surface 31Ab in the axial direction. The downstream casing 31B is formed in an annular shape and provided on the downstream side of the turbine blades 33 in the axial direction and adjacent to the second inner surface 6B in the axial direction. The downstream casing 31B serves as the exhaust diffuser 34a when the turbine blades 33 adjacent thereto are at the last stage, or serves as a turbine stator vane shroud (not illustrated) when the turbine blades 33 adjacent thereto are not at the last stage. The second inner surface 6B is formed so that the inner diameter of the downstream end incrementally expanding outward in the radial direction is substantially equal to the inner diameter of a radial-direction inner surface 31Ba of the downstream casing 31B.

As described above, the seal member 5 allows rotation of the turbine blades 33 by forming a gap between the radial-direction inner surface 5a included in the first inner surface 6A and the front end of the seal fin 334. The gap is preferably as small as possible, but fluid leaks through the gap as indicated by Reference sign g in FIG. 3. Specifically, fluid passes along the first inner surface 6A (the radial-direction inner surface 5a of the seal member 5) toward the downstream side in the axial direction. Having passed along the first inner surface 6A toward the downstream side in the axial direction, the fluid is guided along the second inner surface 6B toward the outer side in the radial direction toward which the second inner surface 6B expands and the downstream side in the axial direction.

Conventionally, as illustrated with a dashed and double-dotted line in FIG. 3, the ring segment 31A has, on the downstream side of the seal member 5 in the axial direction, a flat surface 7 including a step on the outer side of the radial-direction inner surface 5a in the radial direction with the downstream surface 5b of the seal member 5 as a stepped part and continuous in the circumferential direction. In this conventional case, fluid having passed between the seal fin 334 and the radial-direction inner surface 5a of the seal member 5 facing thereto generates vortex flow near Range A beyond the downstream surface 5b as illustrated in FIG. 3. In the conventional case, the downstream surface 31Ab facing toward the downstream side in the flow direction (Arrow G) of the combusted gas (the downstream side in the axial direction) is provided at the downstream end of the flat surface 7, and the downstream casing 31B facing the downstream surface 31Ab is provided on the downstream side of the downstream surface 31Ab in the axial direction. A gap is formed between the flat surface 7 and the downstream casing 31B, and the position of the radial-direction inner surface 31Ba of the downstream casing 31B relative to the flat surface 7 is shifted on the outer side in the radial direction, and thus vortex flow due to a step between the flat surface 7 and the radial-direction inner surface 31Ba of the downstream casing 31B is generated in Range C near the downstream surface 31Ab as illustrated in FIG. 3. Then, the vortex flow in Range A and Range B interferes with the main stream of the combusted gas rotating the turbine blades 33, which causes loss in the kinetic energy of fluid rotating the turbine blades 33.

According to the gas turbine 10 of the present embodiment, unlike such a conventional case, since each seal fin 334 closely faces the first inner surface 6A of the ring segment 31A, it is possible to reduce the amount of fluid (leakage flow) passing toward the downstream side in the axial direction along the first inner surface 6A between the turbine blade 33 and the first inner surface 6A facing thereto. In addition, according to the gas turbine 10, since the first inner surface 6A includes the seal member 5, the seal member 5 is shaved when the seal fin 334 contacts the first inner surface 6A facing thereto due to change in operating conditions, thereby preventing damage on the seal fin 334 and the ring segment 31A. Moreover, according to the gas turbine 10 according to the present embodiment, since leakage flow between the seal fin 334 and the first inner surface 6A (the radial-direction inner surface 5a of the seal member 5) facing thereto is guided along the second inner surface 6B toward the outer side in the radial direction toward which the second inner surface 6B expands and the downstream side in the axial direction, it is possible to reduce generation of vortex flow that would interfere with the main stream on the downstream side of the first inner surface 6A in the axial direction (Range A). Accordingly, even when operation is performed while the seal fin 334 does not contact the seal member 5 and the gap is maintained or when the seal member 5 is shaved by the seal fin 334 due to change in the operation state and the surface shape of the seal member 5 is changed, it is possible to prevent interference of leakage flow having passed between the first inner surface 6A and the seal fin 334 with the main stream rotating the turbine blade, and thus it is possible to reliably obtain an expected effect with the actual machine. In addition, loss in the kinetic energy of fluid rotating the turbine blades 33 can be reduced. In addition, even when the downstream surface 31Ab is provided in the gap between the second inner surface 6B and the downstream casing 31B on the downstream side of the second inner surface 6B in the axial direction, fluid having passed between the seal fin 334 and the first inner surface 6A facing thereto is guided toward the radial-direction inner surface 31Ba of the downstream casing 31B by the second inner surface 6B, and thus generation of vortex flow can be reduced in Range C near the downstream surface 31Ab as illustrated in FIG. 3. Thus, loss in the kinetic energy of fluid rotating the turbine blades 33 can be reduced.

Accordingly, according to the gas turbine 10 of the present embodiment, it is possible to prevent interference of leakage flow at the tip end part of each turbine blade 33 with the main stream rotating the turbine blade 33 and reduce a loss in kinetic energy for rotating the turbine blade 33. As a result, the performance of the gas turbine 10 can be improved. With the configuration in which the first inner surface 6A includes the seal member 5 and faces the seal fin 334 and the ring segment 31B as a rigid body includes the second inner surface 6B connected with the first inner surface 6A on the downstream side of the first inner surface 6A in the axial direction, it is possible to reliably achieve an expected effect with the actual machine when the seal fin 334 contacts the seal member 5.

The turbine 3 has an expanding flow path shape in which the dimension in the radial direction increases toward the downstream side in fluid flow. The exhaust diffuser 34a configured to decelerate fluid as described above is provided as a downstream casing on the downstream side of the turbine blades 33 at the last stage. Thus, when the second inner surface 6B is tilted toward the outer side in the radial direction and the downstream side in the axial direction, fluid having passed between the seal fin 334 and the seal member 5 facing thereto can be guided toward the downstream side in accordance with fluid flow at the exhaust diffuser. In the turbine 3, the turbine stator vane shroud is provided as a downstream casing on the downstream side of the turbine blades 33 other than those at the last stage. Thus, since the second inner surface 6B is tilted toward the outer side in the radial direction and the downstream side in the axial direction, fluid having passed between the seal fin 334 and the seal member 5 facing thereto can be guided to the outer side in the radial direction toward the downstream side in accordance with fluid flow to the turbine stator vane shroud. As a result, interference with the main stream can be reduced on the downstream side of the seal member 5 fixed at a position near the tip end part of each turbine blade 33, and loss in kinetic energy can be reduced.

Moreover, in the gas turbine 10 according to the present embodiment, the first inner surface 6A includes the seal member 5 fixed to the ring segment 31A and accepting contact of the seal fins 334.

When the first inner surface 6A includes the seal member 5 in this manner, the seal member 5 is shaved when any seal fin 334 contacts the first inner surface 6A, thereby preventing damage on the seal fin 334.

In addition, in the gas turbine 10 according to the present embodiment, the downstream surface 5b facing toward the downstream side in the axial direction in the seal member 5 included in the first inner surface 6A is covered by the ring segment 31A on the downstream side in the axial direction as illustrated in FIG. 3.

When the downstream surface 5b of the seal member 5 included in the first inner surface 6A is covered by the ring segment 31A on the downstream side in the axial direction in this manner and the second inner surface 6B is adjacent to the first inner surface 6A, no large stepped part that generates vortex flow is formed, and leakage flow passing toward the downstream side in the axial direction along the first inner surface 6A can be guided along the second inner surface 6B. As a result, it is possible to further reduce a loss caused due to interference of leakage flow at the tip end part of each turbine blade 33 with the main stream, thereby significantly achieving the effect of reducing loss in the kinetic energy of fluid rotating the turbine blade 33. As a result, the performance of the gas turbine 10 can be further improved.

In addition, in the gas turbine 10 according to the present embodiment, the seal member 5 has a tilted inner surface 5e as part of the radial-direction inner surface 5a tilted outward in the radial direction as illustrated in FIG. 4. The second inner surface 6B is provided continuously with the tilted inner surface 5e.

In the gas turbine 10 thus configured, the second inner surface 6B can be disposed on the outer side of the first inner surface 6A (the radial-direction inner surface 5a of the seal member 5) in the radial direction through the tilted inner surface 5e. Accordingly, when the positions of the rotor shaft 4 and any turbine blade 33 in the axial direction are moved relative to the ring segment 31A due to thermal deformation or the like and the seal fin 334 of the turbine blade 33 contacts the seal member 5, the seal fin 334 can be prevented from contacting the second inner surface 6B, thereby preventing damage on the seal fin 334 and the second inner surface 6B.

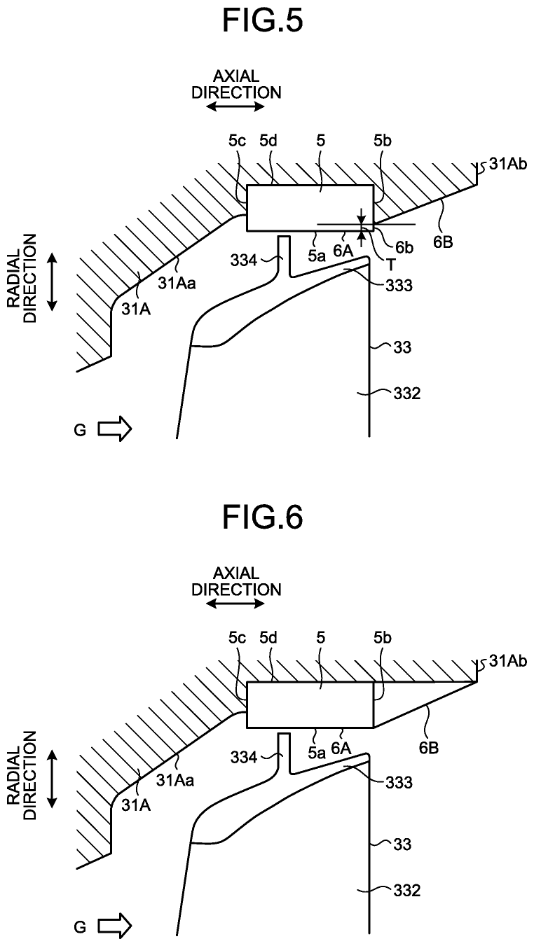

In addition, in the gas turbine 10 according to the present embodiment, connection may be made with a step 6b with which an end part of the seal member 5 on the downstream side in the axial direction protrudes by a dimension T on the inner side of the second inner surface 6B in the radial direction as illustrated in FIG. 5. Specifically, the second inner surface 6B is connected with the downstream surface 5b at such a halfway position that the downstream surface 5b facing toward the downstream side of the seal member 5 in the axial direction is exposed. In other words, connection is made with the step 6b with which the second inner surface 6B is farther separated from the rotor shaft 4 by the dimension T on the outer side in the radial direction than the radial-direction inner surface 5a of the seal member 5.

According to the gas turbine 10 thus configured, when the positions of the rotor shaft 4 and any turbine blade 33 in the axial direction are moved relative to the ring segment 31A due to thermal deformation or the like and the seal fin 334 of the turbine blade 33 contacts the seal member 5, the seal fin 334 can be prevented from contacting the second inner surface 6B, thereby preventing damage on the seal fin 334 the second inner surface 6B.

The dimension T of the step 6b as a protrusion amount by which the end part of the seal member 5 on the downstream side in the axial direction protrudes on the inner side of the second inner surface 6B in the radial direction can be set to be larger than a designed allowable value of an expected depth of shaving of the seal member 5 when the seal fin 334 of any turbine blade 33 contacts the seal member 5, thereby preventing the seal fin 334 of the turbine blade 33 from contacting the ring segment 31A when the seal fin 334 contacts the seal member 5. The dimension T of the step 6b may be set to be smaller than the thickness of the seal member 5 in the radial direction or may be set to be smaller than twice of the designed allowable value, thereby reducing vortex generation due to the step as much as possible.

In addition, in the gas turbine 10 according to the present embodiment, the first inner surface 6A and the second inner surface 6B connected with the first inner surface 6A on the downstream side in the axial direction preferably have no step discontinuous in the axial direction except for the protrusion of the seal member 5.

According to the gas turbine 10 thus configured, since there is no step discontinuous in the axial direction except for the protrusion of the seal member 5, vortex generation due to a step can be prevented.

In addition, in the gas turbine 10 according to the present embodiment, the second inner surface 6B is preferably integrated with the ring segment 31A. In other words, the second inner surface 6B is preferably achieved by the inner surface 31Aa of the ring segment 31A as illustrated in FIG. 3.

According to the gas turbine 10 thus configured, since the second inner surface 6B is formed integrally with the ring segment 31A, the number of components is reduced.

In addition, in the gas turbine 10 according to the present embodiment, the second inner surface 6B may be provided separately from the ring segment 31A as illustrated in FIG. 6.

According to the gas turbine 10 thus configured, since the second inner surface 6B is provided separately from the ring segment 31A, the seal member 5 can be easily replaced, which leads to improved maintainability.

In addition, in the gas turbine 10 according to the present embodiment, the upstream surface 5c of the seal member 5 facing toward the upstream side in the axial direction of the rotational shaft may protrude from the inner surface 31Aa of the ring segment 31A.

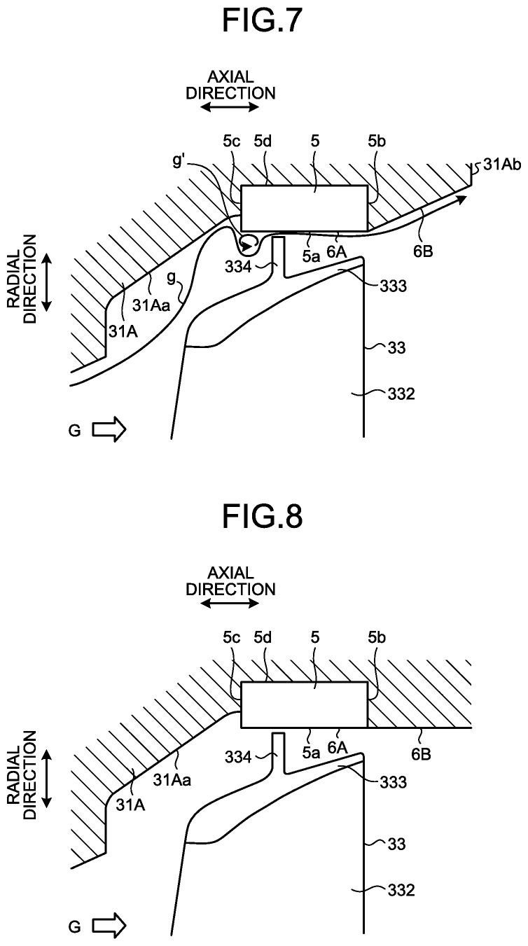

According to the gas turbine 10 thus configured, since the upstream surface 5c of the seal member 5 protrudes from the inner surface 31Aa of the ring segment 31A, a vertex is generated on the inner side of the radial-direction inner surface 5a of the seal member 5 in the radial direction and the upstream side of the seal fin 334 in the axial direction and encumbers Flow g toward the gap between the radial-direction inner surface 5a included in the first inner surface 6A and the front end of any seal fin 334 as indicated by Reference sign g′ in FIG. 7. Accordingly, it is possible to reduce fluid leakage from the gap and reduce interference of this leakage flow with the main stream, thereby significantly achieving the effect of reducing a loss in the kinetic energy of fluid rotating the turbine blade 33. As a result, the performance of the gas turbine 10 can be further improved.

In the above-described embodiment, the second inner surface 6B is a body of rotation having a straight section illustrated in each drawing and has a flat surface, but is not limited to the flat surface. The above-described effect can be achieved, for example, when the second inner surface 6B is formed with a section in a sine curve shape or an arc shape toward the downstream side and the outer side in the radial direction. The sine curve shape or arc shape of the second inner surface 6B formed toward the downstream side and the outer side in the radial direction are included in the above-described tilted form.

### REFERENCE SIGNS LIST

1 compressor
11 air intake
12 compressor casing
13 compressor vane
14 compressor rotor blade
2 combustor
21 combustor basket
22 transition piece
23 outer barrel
24 combustor casing
25 flow path
3 turbine
31 turbine casing
31A ring segment
31Aa inner surface
31Ab downstream surface
31B downstream casing
31Ba radial-direction inner surface
32 turbine stator vane
33 turbine blade
331 blade root portion
332 blade airfoil portion
333 tip shroud
334 seal fin
335 shroud
34 exhaust manifold
34a exhaust diffuser
4 rotor shaft (rotational shaft)
41 bearing
42 bearing
5 seal member
5a radial-direction inner surface
5b downstream surface
5c upstream surface
5d radial-direction outer surface
5e tilted inner surface
6A first inner surface
6B second inner surface
7 plane
10 gas turbine
A range
C range
R center axis

1. A turbo machine comprising:
a casing in which fluid flows;
a plurality of turbine blades arranged side by side in a circumferential direction with respect to a rotational shaft rotatably provided in the casing;
a ring segment forming an inner surface of the casing;
a seal fin provided as an extension at a tip end part of each turbine blade and facing the ring segment; and
a seal member through which the turbo machine faces the seal fin, the seal member having a first inner surface that accepts contact of the seal fin, the seal member being provided on a radial-direction inner surface of the ring segment, wherein
the ring segment has a second inner surface incrementally enlarging toward a downstream side in an axial direction of the rotational shaft, the second inner surface being a different rigid body from the seal member,
the first inner surface is configured such that there is no step in the axial direction between an upstream surface of the seal member that faces toward an upstream side in the axial direction of the rotational shaft and a downstream surface of the seal member that faces toward the downstream side in the axial direction of the rotational shaft, and a radial-direction inner surface of the seal member is parallel to the rotational shaft, and
the first inner surface and the second inner surface are connected with each other without a step between the inner surfaces on the downstream side of the first inner surface in the axial direction.

2. A turbo machine comprising:
a casing in which fluid flows;
a plurality of turbine blades arranged side by side in a circumferential direction with respect to a rotational shaft rotatably provided in the casing;
a ring segment forming an inner surface of the casing;
a seal fin provided as an extension at a tip end part of each turbine blade and facing the ring segment; and
a seal member through which the turbo machine faces the seal fin, the seal member having a first inner surface that accepts contact of the seal fin, the seal member being provided on a radial-direction inner surface of the ring segment, wherein
the ring segment has a second inner surface incrementally enlarging toward a downstream side in an axial direction of the rotational shaft, the second inner surface being a different rigid body from the seal member,
the first inner surface is configured such that there is no step in the axial direction between an upstream surface of the seal member that faces toward an upstream side in the axial direction of the rotational shaft and a downstream surface of the seal member that faces toward the downstream side in the axial direction of the rotational shaft, and a radial-direction inner surface of the seal member is parallel to the rotational shaft,
the first inner surface and the second inner surface are connected with each other on the downstream side in the axial direction of the first inner surface with a step such that the first inner surface protrudes on an inner side with respect to the second inner surface in a radial direction, the step being smaller than a thickness of the seal member, and
the upstream surface of the seal member that faces toward the upstream side in the axial direction of the rotational shaft protrudes from the inner surface of the ring segment, a step between the protruded upstream surface and the inner surface of the ring segment being smaller than the thickness of the seal member.

3. A turbo machine comprising:
a casing in which fluid flows;
a plurality of turbine blades arranged side by side in a circumferential direction to a rotational shaft rotatably provided in the casing;
a ring segment forming an inner surface of the casing; and
a seal fin provided as an extension at a tip end part of each turbine blade and facing the ring segment; and
a seal member facing the seal fin as an extension at the tip end part of each turbine blade at a last stage and having a first inner surface that accepts contact of the seal fin, the seal member being provided on a radial-direction inner surface of the ring segment, wherein
the ring segment has a second inner surface having an inner diameter incrementally increasing toward a downstream side in an axial direction of the rotational shaft, the second inner surface being a different rigid body from the seal member,
the first inner surface is configured such that there is no step in the axial direction between an upstream surface of the seal member that faces toward an upstream side in the axial direction of the rotational shaft and a downstream surface of the seal member that faces toward the downstream side in the axial direction of the rotational shaft, and a radial-direction inner surface of the seal member is parallel to the rotational shaft,
the first inner surface and the second inner surface are connected with each other on the downstream side in the axial direction of the first inner surface with a step such that the first inner surface protrudes on an inner side with respect to the second inner surface in a radial direction, and
the upstream surface of the seal member that faces toward the upstream side in the axial direction of the rotational shaft protrudes from the inner surface of the ring segment, a step between the protruded upstream surface and the inner surface of the ring segment being smaller than the thickness of the seal member.

4. (canceled)

5. The turbo machine according to claim 3, wherein the first inner surface and the second inner surface connected with the first inner surface on the downstream side in the axial direction have no step discontinuous in the axial direction except for the protrusion of the seal member.

6. The turbo machine according to claim 3, wherein the amount of the protrusion of the seal member is larger than a depth to which shaving by the seal fin is expected and smaller than twice of the depth.

7. The turbo machine according to claim 3, wherein the second inner surface is integrated with the ring segment.

8. The turbo machine according to claim 3, wherein the second inner surface is provided separately from the ring segment.

9. The turbo machine according to claim 1, wherein the upstream surface of the seal member that faces toward the upstream side in the axial direction of the rotational shaft protrudes from the inner surface of the ring segment.

10. The turbo machine according to claim 1, wherein the second inner surface is integrated with the ring segment.

11. The turbo machine according to claim 1, wherein the second inner surface is provided separately from the ring segment.

12. The turbo machine according to claim 2, wherein the first inner surface and the second inner surface connected with the first inner surface on the downstream side in the axial direction have no step discontinuous in the axial direction except for the protrusion of the seal member.

13. The turbo machine according to claim 2, wherein the amount of the protrusion of the seal member is larger than a depth to which shaving by the seal fin is expected and smaller than twice of the depth.

14. The turbo machine according to claim 2, wherein the second inner surface is integrated with the ring segment.

15. The turbo machine according to claim 2, wherein the second inner surface is provided separately from the ring segment.
